(19) United States
(12) Patent Application Publication
(10) Pub. No.: US 2006/0286336 A1
(43) Pub. Date: Dec. 21, 2006

(54) Puzzle-cut seamed belts

(75) Inventors: John Joseph Darcy III, Webster, NY (US); Michael Stephen Roetker, Webster, NY (US); David W. Martin, Walworth, NY (US); Felix J. Santana, San German, PR (US); Scott Griffin, Fairport, NY (US); Richard L. Post, Penfield, NY (US)

Correspondence Address: PILLSBURY WINTHROP SHAW PITTMAN, LLP, P.O. BOX 10500, MCLEAN, VA, 22102, US

(73) Assignee: XEROX CORPORATION, Stamford, CT (US)

(21) Appl. No.: 11/155,677

(22) Filed: Jun. 20, 2005

(51) Int. Cl. G03G 15/04; B32B 3/00

(52) U.S. Cl. 428/57; 430/69; 156/304.5; 399/162

(57) ABSTRACT

Flexible imaging belts having a seam comprising puzzle-cut edges joined by heat-treating a carbon-black filled polyimide.

### BACKGROUND

All references cited in this specification, and their references, are incorporated by reference herein where appropriate for teachings of additional or alternative details, features, and/or technical background.

Disclosed in the embodiments herein are flexible imaging belts having a seam comprising puzzle-cut edges joined by heat-treated carbon-black loaded polyimide.

Typical flexible belts used for different kinds of practical application are, generally, prepared in either a seamed or a seamless belt configuration. These flexible belts are commonly utilized to suit numerous functioning purposes such as electrostatographic imaging member belts, conveyor belts, drive belts, intermediate image transfer belts, sheet transport belts, document handling belts, donor belts for transporting toner particles, motor driving belts, torque assist driven belts, and the like.

Flexible belts, such as electrostatographic imaging member belts, are well known in the art. Typical electrostatographic flexible imaging members include, for example, photoreceptors for electrophotographic imaging systems, and electroreceptors or ionographic imaging members for electrographic imaging systems. Both electrophotographic and electrographic imaging member belts are commonly utilized in a seamed belt configuration based from ease of belt fabrication and cost considerations, even though seamless imaging belts are preferred since the whole belt surface is a viable imaging area.

For electrophotographic applications, the flexible electrophotographic imaging member or photoreceptor belts preferably comprise a flexible substrate support coated with one or more layers of photoconductive material. The substrate supports are usually organic materials such as a film forming thermoplastic polymer. The photoconductive coatings applied to these substrates may comprise inorganic materials such as selenium or selenium alloys, organic materials, or combinations of organic and inorganic materials. The organic photoconductive layers may comprise, for example, a single binder layer having dissolved or dispersed therein a photosensitive material or multilayers comprising, for example, a charge generating layer and a charge transport layer. The charge generating layer is capable of photogenerating holes and injecting the photogenerated holes into the charge transport layer.

The flexible electrographic imaging or ionographic belts though analogous to photoreceptor belts are, however, of simpler material design; these belts, in general, comprise either a flexible single layer conductive substrate support or an insulating substrate support having a conductive metallic surface and overcoated on a dielectric imaging layer. The basic process for using electrostatographic flexible imaging member belts is well known in the art.

As more advanced, higher speed electrophotographic copiers, duplicators and printers were developed, degradation of image quality was encountered during extended cycling. Moreover, complex, highly sophisticated duplicating and printing systems operating at very high speeds have placed stringent requirements including narrow operating limits on photoreceptors.

One typical type of multilayered imaging member that has been employed as a belt in electrophotographic imaging systems comprises a substrate, a conductive layer, a hole blocking layer, an adhesive layer, a charge generating layer, a charge transport layer, and a conductive ground strip layer adjacent to one edge of the imaging layers. This imaging member may also comprise additional layers, such as an anti-curl back coating layer to flatten the imaging member and an optional overcoating layer to protect the exposed charge transport layer from wear.

The electrophotographic imaging flexible member is usually fabricated from a sheet cut from an imaging member web. The sheets are generally rectangular in shape. All sides may be of the same length, or one pair of parallel sides may be longer than the other pair of parallel sides. The expression “rectangular,” as employed herein, is intended to include four-sided sheets where all sides are of equal length or where the length of two equal parallel sides is unequal to the other two equal parallel sides.

The sheets are fabricated into a belt by overlapping opposite marginal end regions of the sheet. A seam is typically produced in the overlapping marginal end regions at the site of joining. Joining may be effected by any suitable means. Typical joining techniques include welding (such as ultrasonic welding), gluing, taping, pressure heat fusing and the like. Typical seamed electrostatographic imaging member belts commonly employed in imaging machines have a welded seam formed from ultrasonic welding process.

Ultrasonic welding may be the method chosen for joining a flexible imaging member because it is rapid, clean and solvent-free and low cost, as well as because it produces a thin and narrow seam. In addition, ultrasonic welding may be preferred because the mechanical high frequency pounding of the welding horn causes generation of heat at the contiguous overlapping end marginal regions of the flexible imaging sheet loop to maximize melting of one or more layers therein to form a strong and precisely defined seam joint. Ultrasonic welding may also be chosen for joining flexible polymeric sheets because of its speed, cleanliness (absence of solvents) and production of a strong seam. The melting of the coating layers of the photoconductive sheet provide direct substrate to substrate contact of the opposite ends and fusing them into a seam.

Ultrasonic welding is a process that uses high frequency mechanical vibrations above the audible range. The vibrations are produced at the tip of a welding sonotrode or horn. The vibratory force emanating from such a horn device can be generated at high enough frequencies to soften or melt thermoplastic material components intended to be joined together. For example, such frequencies can be effective at 20, 30 or 40 kHz. One of the main advantages of ultrasonic welding may be found in the very short welding steps that enhance its usefulness even in mass production. Weld times may last less than a second. Thus, the process has been utilized in many industries and applications. The ultrasonic welding process may entail holding down the overlapped ends of a flexible imaging member sheet with vacuum against a flat anvil surface and guiding the tip end of an ultrasonic vibrating horn transversely across the entire width of the sheet, over and along the overlapped ends, to form a welded seam. The ultrasonic vibration frequency applied for joining the photoreceptor belt/loop ends is kept so high that a frictional heat results upon contact with material to be joined. The heat causes softening or melting of contact portion which results in fusing the joined belt end pieces without any horn burn blemishes in the form of undesirable raised, rough and brittle welds.

The seaming of a flexible image transfer belt is important in terms of its strength. Acceptable flexible image transfer belts require sufficient seam strength to achieve a desired operating life. Considering that a seamed transfer belt suffers from mechanical stresses from belt tension, traveling over rollers, moving through transfer nips and passing through cleaning systems, achieving a long operating life is not trivial. The conflicting constraints of long life and limited topographical size at the seam place a premium on adhesive strength and good seam construction.

The typical butting technique while satisfactory for many purposes are limited in bonding, strength and flexibility because of the limited contact area formed by merely butting or overlapping the two ends of the belt material. Furthermore, belts formed according to the butting or overlapping technique provide a bump or other discontinuity in the belt surface leading to a height differential between adjacent portions of the belt of 0.010 inches or more depending on the belt thickness, which leads to performance failure in many applications. For example, one of the most severe problems involves cleaning the imaging belt of residual toner after transfer of the toner image. Intimate contact between the belt and cleaning blade is required. With a bump, crack or other discontinuity in the belt the tuck of the blade is disturbed, which allows toner to pass under the blade and not be cleaned. Furthermore, seams having differential heights may when subjected to repeated striking by cleaning blades cause the untransferred, residual toner to be trapped in the irregular surface of the seam. Photoreceptors which are repeatedly subjected to this striking action tend to delaminate at the seam when the seam is subjected to constant battering by the cleaning blade. As a result, both the cleaning life of the blade and the overall life of the photoreceptor can be greatly diminished as well as degrading the copy quality. In addition, such irregularities in seam height provide vibrational noise in xerographic development which disturbs the toner image on the belt and degrades resolution and transfer of the toner image to the final copy sheet. This is particularly prevalent in those applications requiring the application of multiple color layers of liquid or dry developer on a photoreceptor belt, which are subsequently transferred to a final copy sheet.

To improve mechanical strength of the seam, a “puzzle-cut” approach has been employed. Puzzle-cut joined seams are based on an intimate male-female puzzle pattern interlocking. Part of the strength of a puzzle-cut seam relates to the increased seam surface area, and at least part is due to the improved distribution of lateral forces. While laterally very strong, puzzle-cut seams have been seen to pop open and separate when the butt joint puzzle-cut seam of a flexible-imaging belt bends and flexes over a small diameter support roller, which may result in total seam separation.

Attempts to improve puzzle-cut seams include applying thin adhesive strips over the puzzle-cut seam joint to permanently secure the joint and resolve the seam bending induced popping problem. Such adhesive strips have been found, however, in a number of cases to add significant thickness to the resulting puzzle-cut seam, thereby diminishing the practical value of the seam. The application of heat to the adhesive tape to form a more secure joining with minimal thickness aberrations has been proposed. However, the application of high levels of heat has a tendency to distort the nodes of the puzzle-cut pattern, causing thermal and mechanical stresses in the belt material, which may end up forming little ripples in the belt material, resulting in a copy quality defect such as a lack of transfer of toner material resulting in a print deletion. To overcome this problem, it has been proposed to incorporate voids between the surfaces of mutually mating elements and to incorporate in such voids an ultraviolet light radiation cured adhesive to join together the mating elements more efficiently.

Image belts comprising a polyimide, in particular a carbon-black filled polyimide like Kapton, have been found to be particularly useful, especially in respect to flexibility and wear resistance. A great deal of effort has been undertaken to produce seamless polyimide image belts for making a seamed polyimide belt.

### REFERENCES

U.S. Patent Publication No. 2002/0074082 A1 (U.S. patent application Ser. No. 09/683,329) discloses in embodiments a seamless flexible electrostatographic imaging member having puzzle-cut tabs interlocked together and a method for manufacturing the same. A polyamide adhesive layer is disclosed to bond the overlap in a Kapton seamed belt.

U.S. Patent Publication No. 2002/0074520 A1 (U.S. patent application Ser. No. 09/683,332) discloses an apparatus employing a beam source and beam spreader to manufacture seamless flexible electrostatographic imaging members. Seam bonding is said to include ultrasonic welding, gluing, stapling, and the like. Kapton seem overlap joining is said to be formed by using a polyamide adhesive.

U.S. Pat. No. 6,681,671, commonly assigned, discloses a method and system for cutting puzzle-cut petals in belts.

U.S. Pat. No. 6,669,800, commonly assigned, discloses a belt formed from a semiconductive substrate having a first end and a second end that are mated to form a seam. An adhesive is disposed over the joint, whereupon a joint can be burnished or overcoated with a material that substantially imitates predefined surface properties of the belt.

U.S. Pat. No. 6,488,798, commonly assigned, discloses a method of making imageable seamed intermediate transfer belts having burnished seams.

U.S. Pat. No. 6,457,392, commonly assigned, discloses a method and apparatus for producing an endless flexible seamed belt using a punch and die. The punch and die have patterned edges in the form of a puzzle-cut pattern with extremely small nodes and kerfs.

U.S. Pat. No. 6,440,515, commonly assigned, discloses seamed belts having a puzzle-cut seam with edges that are themselves puzzle-cut.

U.S. Pat. No. 6,368,440, commonly assigned, discloses a flexible electrostatographic imaging belt comprising two ends with matching puzzle-cut patterns of fingers arranged to be joined. An adhesive strip is applied to the juncture comprising the two belt ends, and then heated and cooled. If the puzzle-cut seam is not satisfactory, the heating and cooling steps are repeated.

U.S. Pat. No. 5,487,707, commonly assigned, discloses an endless flexible seamed belt having opposite surfaces of mutually mating elements bound by an adhesive which is cured by exposure to ultraviolet radiation.

U.S. Pat. No. 5,514,436, commonly assigned, discloses an endless flexible seamed belt wherein the two ends of the material from which the belt is fabricated has a plurality of mutually mating elements in a puzzle-cut pattern which are in interlocking relationship in at least one plane.

### SUMMARY

Aspects disclosed herein include:

a method for manufacturing an endless, seamed, flexible belt fabricated from a carbon-filled polyimide polymer and having a first end and a second end, the method comprising forming, at each end, elements in a puzzle-cut pattern such that mutually mating elements are formed between each end of the belt wherein the mutually mating elements form a gap between the mutually mating elements (“kerf”); interlocking the mutually mating elements of the first end with the second end; filling in the gaps between the mutually mating elements with a carbon-black filled polyimide polymer paste; and heat-treating the polymer paste to form a solid joint;

a seamless flexible electrostatographic imaging member belt fabrication method comprising providing a flexible substrate support sheet, the flexible support sheet fabricated from a carbon-black filled polyimide material; producing first desired features on a first portion of the substrate support sheet, including contouring material from the substrate support sheet with a monochromatic emission of a wavelength of about 100 nanometers to about 690 nanometers, or from about 180 nanometers to about 400 nanometers; producing second desired features on a second portion of the substrate support sheet complementary to the first desired features, including contouring material from the substrate support sheet with a monochromatic emission of a wavelength of about 100 nanometers to about 690 nanometers, or from about 180 nanometers to about 400 nanometers; overlapping the first and second desired features; and bonding the first desired pattern with the second desired pattern to produce a seamed belt; and

a seamed flexible electrostatographic imaging belt fabricated from a carbon-black filled polyimide polymer, the belt having two ends having a plurality of mutually mating elements in a puzzle-cut pattern, the opposite surfaces of the two ends being in an interlocking relationship to prevent separation of the two ends, the surfaces of the mutually mating elements defining voids therebetween, of sufficient size to permit filling the voids with a carbon-black filled polyimide polymer.

### BRIEF DESCRIPTION OF THE DRAWINGS

Various of the above mentioned and further features and advantages will be better understood from this description of embodiments thereof, including the attached drawing figures wherein:

FIG. 1 is an isometric representation of a puzzle-cut seamed intermediate transfer belt;

FIG. 2 is a top down view of an exemplar puzzle-cut “teardrop” shaped tab pattern that may be used on the joining ends of an embodiment belt;

FIG. 3 is a top down view of an exemplar “T-shaped” puzzle-cut tab pattern where male and female interlocking portions have curved mating elements that may be used on the joining ends of an embodiment belt;

FIG. 4 is a top down view of an exemplar “dovetail” shaped puzzle-cut tab pattern having curved mating elements that may be used on the joining ends of an embodiment belt;

FIG. 5 is a top down view of an exemplar puzzle-cut tab pattern wherein the pattern at both ends is formed from a plurality of finger joints that may be used on the joining ends of an embodiment belt; and

FIG. 6 is a greatly exaggerated in scale representation illustrating essentially a small kerf or space between interlocking elements, the kerf being filled with a carbon-black filled polyimide.

### DETAILED DESCRIPTION

In embodiments, there is illustrated a method for manufacturing an endless, seamed, flexible belt fabricated from a carbon-filled polyimide polymer and having a first end and a second end, the method comprising forming, at each end, elements in a puzzle-cut pattern such that mutually mating elements are formed between each end of the belt wherein the mutually mating elements form a gap between the mutually mating elements (“kerf”); interlocking the mutually mating elements of the first end with the second end; filling in the gaps between the mutually mating elements with a carbon-black filled polyimide polymer paste; and heat-treating the polymer paste to form a solid joint.

In such method, the puzzle-cut ends can be of any shape, including dovetail shaped, T-shaped, or teardrop shaped. The carbon-black filled polyimide comprising the belt and/or the paste may comprise Kapton. The belt itself may further be coated with a photoconductive coating comprising inorganic materials such as selenium or selenium alloys, or organic materials, or combinations of organic and inorganic materials. The organic photo conductive layer may comprise, for example, a single binder layer having dissolved or dispersed photosensitive material, or a multilayer comprising, for example, a charge generating layer and a charge transport layer. The charge generating layer is capable of photogenerating holes and injecting the photogenerated holes into the charge transport layer. The belt may alternatively or additionally comprise an ionographic imaging belt comprising, for example, a substrate having a conductive metallic surface overcoated on a dielectric imaging layer.

The carbon-black filled polyimide paste may be filled into gaps between the mutually mating elements (the so-called “kerf”) either by directed application to the kerf, precision dispensing equipment, or any other manner such as by overcoating a portion of the belt proximate to the puzzle-cut seam and removing excess paste with a cleaning blade. Excess paste or heat-treated carbon-black filled polyimide may be removed by monochromatic ablation, such as laser ablation. Laser ablation of such material at about 100 nanometers to about 690 nanometers, or about 180 nanometers to about 400 nanometers, may cause breaking of the molecular bonds of the material rather than by melting, which may allow for a cleaner bond surface.

Flashing of the puzzle-cut elements may be reduced by contouring the mating elements using a monochromatic emission source, such as a laser, emitting a wavelength of 100 nanometers to about 690 nanometers, or about 180 nanometers to about 400 nanometers, by reducing irregularities due to melting. At least one of the emissions may be of a wavelength of about 190 nanometers to about 200 nanometers or about 240 nanometers to about 250 nanometers, or about 340 nanometers to about 360 nanometers.

In one embodiment, there is disclosed a seamed flexible electrostatographic imaging belt fabricated from a carbon-black filled polyimide polymer, the belt having two ends having a plurality of mutually mating elements in a puzzle-cut pattern, the opposite surfaces of the two ends being in an interlocking relationship to prevent separation of the two ends, and the surfaces of the mutually mating elements defining voids therebetween, of sufficient size to permit filling the voids with a carbon-black filled polyimide polymer.

In such an embodiment, the filled kerf may be sought to be at a level that is commensurate with the level of the belt material on each side of the kerf to allow for a “seamless” seam. Such level may be achieved by masking over the belt material surrounding the seam (or portion thereof) and laser ablating the excess carbon-black filled polyimide paste or heat-treated seam material. The excess may also be reduced using a monochromatic emission with a wavelength of about 100 nanometers to about 690 nanometers, or from about 180 nanometers to about 400 nanometers, alternatively from about 190 nanometers to about 200 nanometers, from about 240 nanometers to about 250 nanometers, or from about 340 nanometers to about 360 nanometers.

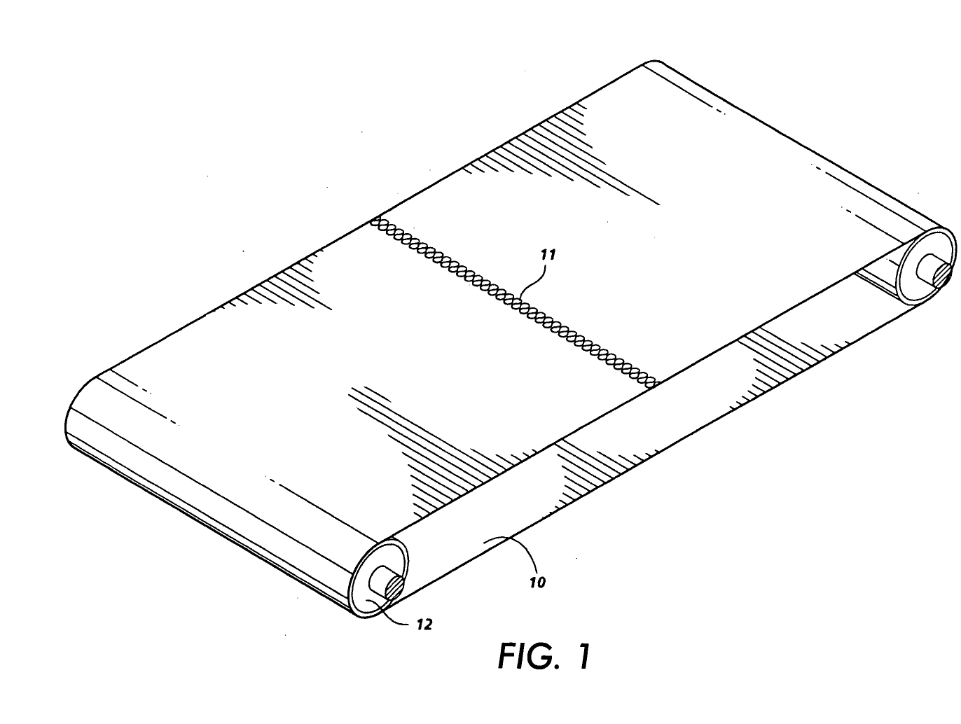

Referring to FIG. 1, it should be noted that the mechanical interlocking relationship of the seam 11 is present in a two dimensional plane when the belt 10 is on a flat surface, whether it be horizontal or vertical. While the seam is illustrated in FIG. 1 as being perpendicular to the two parallel sides of the belt it will be understood that it may be angled or slanted with respect to the parallel sides. This enable any noise generated in the system to be distributed more uniformly and the forces placed on each mating element or node to be reduced.

The puzzle-cut pattern may be formed according to any conventional shaping technique, such as by die cutting or laser cutting with commercially available lasers, such as a CO₂ laser or excimer laser generating a beam of sufficient width and intensity that within an acceptable time will provide the desired cut. Following cutting by the laser beam it can be deburred and cleaned by air, ultrasonics or brushing if necessary. Reduction in flashing may be noted when the puzzle-cut edges are contoured (either during cutting process or after cutting) using a monochromatic emission of a wavelength of from about 100 nanometers to about 690 nanometers, or from about 180 nanometers to about 400 nanometers. Useful wavelengths include from about 190 nanometers to about 200 nanometers, from about 240 nanometers to about 250 nanometers, and from about 340 nanometers to about 360 nanometers. In addition to puzzle cut patterns formed by joining the two ends, they may be formed on each of the ends by a male and female punch with the belt material in between which punches out the shape. Alternatively, it could be a pattern on a wheel which rolls over the material.

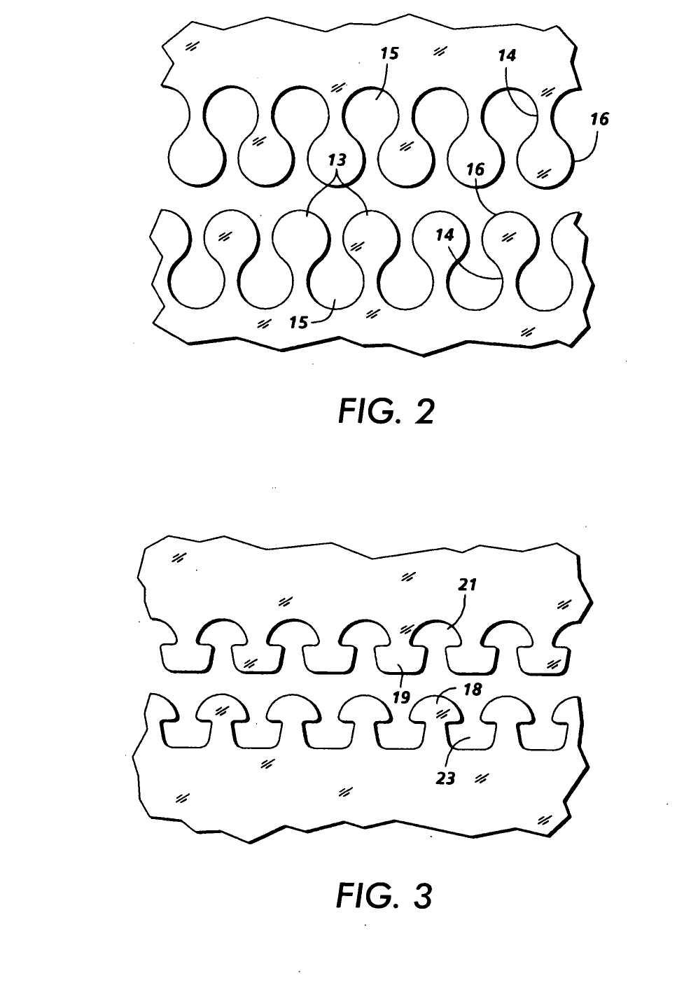

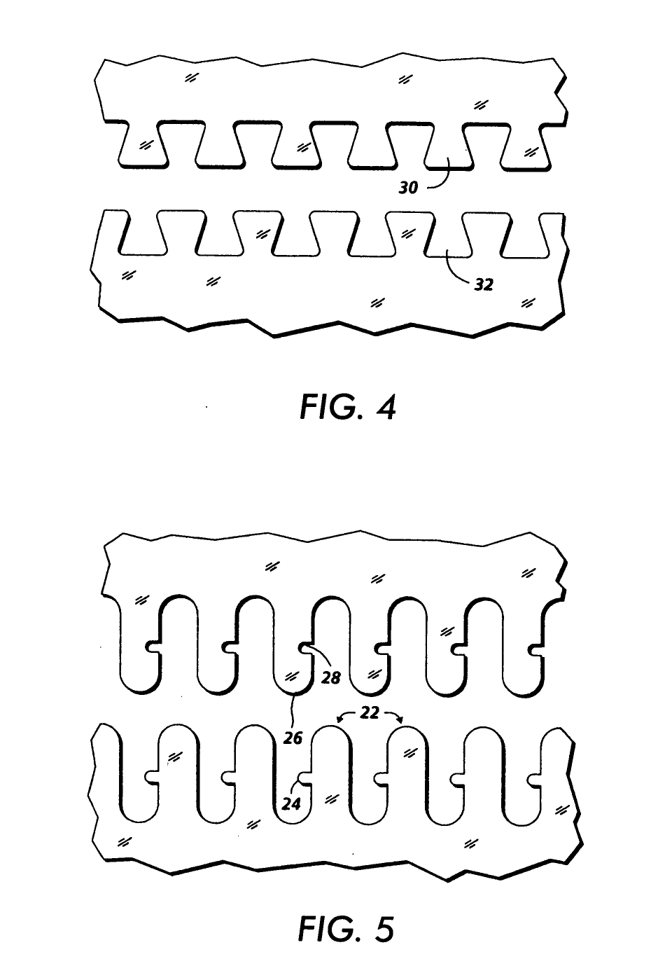

As may be observed from the drawings, the puzzle cut pattern may take virtually any form, including that of teeth or nodes such as identical post or neck 14 and head 16 patterns of male 13 and female 15 interlocking portions in a “teardrop” pattern as illustrated in FIG. 2, or a more “T-shaped,” such as a mushroom-like shaped pattern, having male portions 18 and 19 and female portions 21 and 23 as illustrated in FIG. 3 as well as a dovetail pattern as illustrated in FIG. 4. The puzzle-cut pattern illustrated in FIG. 5 has a plurality of male fingers 22 with interlocking teeth 24 and plurality of female fingers 26 which have recesses 28 to interlock with the teeth 24 when assembled. Interlocking elements may all have curved mating elements to reduce the stress concentration between the interlocking elements and permit them to separate when traveling around curved members such as the rolls 12 of FIG. 1. With curved mating elements, the stress concentration may be lower than with square corners where rather than the stress being uniformly distributed it is concentrated leading to possible failure.

The mechanical bonding strength and flexibility of the bond should be capable of supporting a belt cycling of at least 500,000 and the height differential between the seamed portion and the unseamed portion on each side of the seam about 0.001 inch and the seam have a tensile strength of at least 80% and preferably 90% of the parent belt material strength.

To minimize any time out or nonfunctional area of the belt it may be desirable to have the seam width be as narrow as possible. Further, this enables the seam to be indexed so that it does not participate in belt functionality such as the formation and transfer of a toner or developer image. Typically, the seam is from about 1 mm to about 3 mm wide.

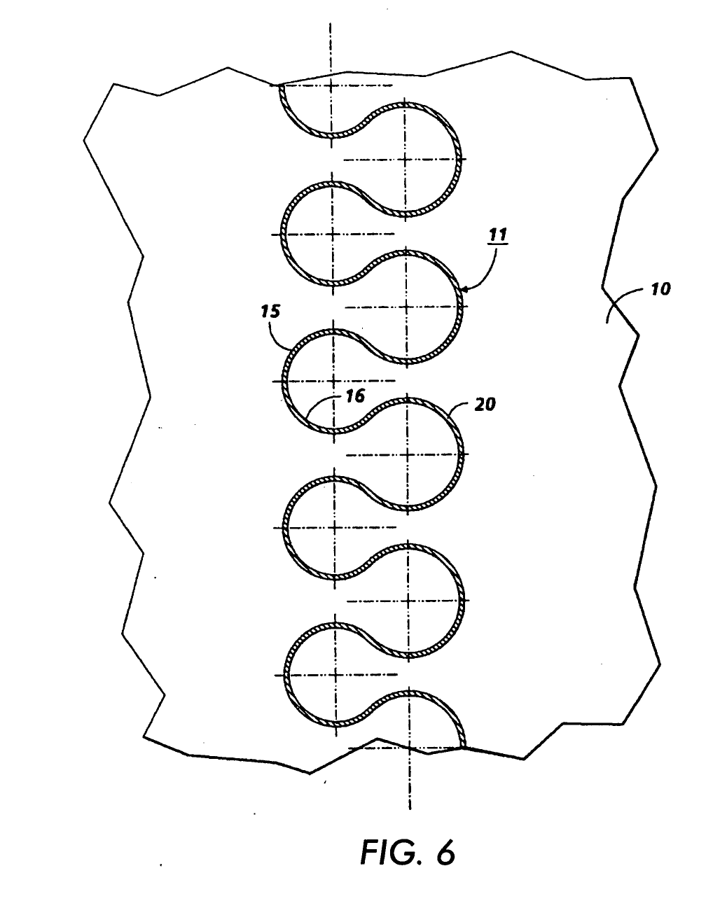

Now turning to FIG. 6, there is shown a greatly exaggerated in scale representation of a belt 10 illustrating essentially a small kerf or space 20 between interlocking elements 16 and 15, the kerf or space 20 being filled with a carbon-black filled polyimide 11, such as Kapton.

While the invention has been particularly shown and described with reference to particular embodiments, it will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for manufacturing an endless, seamed, flexible belt fabricated from a carbon-filled polyimide polymer and having a first end and a second end, said method comprising
forming, at each end, elements in a puzzle-cut pattern such that mutually mating elements are formed between each end of said belt wherein said mutually mating elements form a gap between the mutually mating elements (“kerf”);
interlocking said mutually mating elements of said first end with said second end;
filling in said gaps between said mutually mating elements with a carbon-black filled polyimide polymer paste; and
heat-treating the polymer paste to form a solid joint.

2. A method in accordance with claim 1 wherein at least one puzzle-cut end is “T-shaped” in geometry.

3. A method in accordance with claim 1 wherein at least one puzzle-cut end is “dovetail” shaped in geometry.

4. A method in accordance with claim 1 wherein at least one puzzle-cut end is “teardrop” shaped in geometry.

5. A method in accordance with claim 1 wherein the carbon-black filled polyimide polymer paste comprises Kapton.

6. A method in accordance with claim 1 wherein the carbon-black filled polyimide polymer comprising said belt is Kapton.

7. A method in accordance with claim 1 wherein the carbon-black filled polyimide polymer paste is filled into the gaps by overcoating the belt with paste and removing excess paste with a cleaning blade.

8. A method in accordance with claim 1 wherein the belt has a photoconductive coating applied thereto.

9. A method in accordance with claim 8 wherein the photoconductive layer comprises a charge generating layer and a charge transport layer.

10. A method in accordance with claim 1 further comprising laser ablating excess carbon-black filled polyimide found at the seam.

11. A seamless flexible electrostatographic imaging member belt fabrication method comprising
providing a flexible substrate support sheet, said flexible support sheet fabricated from a carbon-black filled polyimide material;
producing first desired features on a first portion of the substrate support sheet, including contouring material from the substrate support sheet with a monochromatic emission of a wavelength of about 100 nanometers to about 690 nanometers, or from about 180 nanometers to about 400 nanometers;
producing second desired features on a second portion of the substrate support sheet complementary to the first desired features, including contouring material from the substrate support sheet with a monochromatic emission of a wavelength of about 100 nanometers to about 690 nanometers, or from about 180 nanometers to about 400 nanometers;
overlapping the first and second desired features;
bonding the first desired pattern with the second desired pattern to produce a seamed belt.

12. A method in accordance with claim 11 wherein said first desired features and second desired features are produced to form a kerf between said first and second desired features when said features are overlapped.

13. A method in accordance with claim 12 further including filling the kerf with a carbon-black filled polyimide paste after overlapping the first and second desired features.

14. A method in accordance with claim 13 further including leveling said carbon-black filled polyimide paste in said kerf to the same level as the adjoining elements.

15. A method in accordance with claim 13 further including heating the carbon-black filled polyimide paste after filling said kerf.

16. A method in accordance with claim 11 wherein at least one of said emissions is of a wavelength of from about 190 nanometers to about 200 nanometers, or from about 240 nanometers to about 250 nanometers, or from about 340 nanometers to about 360 nanometers.

17. A method in accordance with claim 15 further including laser ablating the carbon-black filled polyimide kerf to reduce any seam flashing.

18. A seamed flexible electrostatographic imaging belt fabricated from a carbon-black filled polyimide polymer, said belt having two ends having a plurality of mutually mating elements in a puzzle-cut pattern, the opposite surfaces of the two ends being in an interlocking relationship to prevent separation of the two ends, the surfaces of the mutually mating elements defining voids therebetween, of sufficient size to permit filling said voids with a carbon-black filled polyimide polymer.

19. A flexible seamed electrostatographic imaging belt in accordance with claim 18 wherein the carbon-black filled polyimide is Kapton.

20. A flexible seamed electrostatographic imaging belt in accordance with claim 18 wherein at least one puzzle-cut end is shaped in a geometry selected from the group consisting of a dovetail, a teardrop, or T-shaped.
